(19) United States
(12) Patent Application Publication
(10) Pub. No.: US 2025/0138863 A1
(43) Pub. Date: May 1, 2025

(54) SENSITIVITY SCANNING IN DISTINCT HOSTING ENVIRONMENTS

(71) Applicant: Royal Bank of Canada, Toronto (CA)

(72) Inventors: Duy Quoc VU, Mississauga (CA); Danny HUI, Toronto (CA); Kevin JIANG, Toronto (CA); Vinh TRAN, Toronto (CA); Mohit ARORA, Oakville (CA)

(21) Appl. No.: 18/930,707

(22) Filed: Oct. 29, 2024

Related U.S. Application Data
(60) Provisional application No. 63/594,207, filed on Oct. 30, 2023.

(51) Int. Cl. G06F 9/455

(52) U.S. Cl. CPC G06F 9/45558; G06F 2009/45591

(57) ABSTRACT

A method for monitoring a file system within a distributed network is provided. From a local hosting environment having a native scanning tool, creation of a new data store within the network is detected. Responsive to detecting creation of the new data store, it is determined whether the new data store is physically located within a foreign hosting environment that is communicatively coupled to the local hosting environment through a non-private network. If the new data store is physically located within the foreign hosting environment, an agent of the native scanning tool is created within the foreign hosting environment and the agent is applied to the new data store within the foreign hosting environment to obtain sensitivity information for the new data store. The sensitivity information for the new data store is received and recorded in the local hosting environment.

### CROSS-REFERENCE TO RELATED APPLICATION

This application claims the benefit of U.S. Provisional Patent Application No. 63/594,207 filed on Oct. 30, 2023, the teachings of which are hereby incorporated by reference.

### TECHNICAL FIELD

The present disclosure relates to distributed computer networks, and more particularly to detecting sensitivity information in file systems of distributed computer networks.

### BACKGROUND

Distributed computer networks pose challenges to the protection of sensitive information, such as personal information. Various types of protection can be deployed, such as firewalls and access controls, to limit access to sensitive information to authorized personnel.

Access control alone, however, does not entirely address the challenge. There is also a risk that sensitive information may be misclassified, or located in data stores that are not set up to properly protect sensitive information. Thus, good practice requires an awareness of where sensitive information is actually stored, as compared to where it should be stored. Accordingly, having a single scanning tool that can evaluate the sensitivity of data in disparate data stores across distinct hosting environments would be valuable.

However, the nature of distributed computer networks is such that the data centers for various hosting environments may be connected to one another through wide area networks that are accessible to third parties, for example the Internet. Therefore, trying to operate a single scanning tool to evaluate data sensitivity raises its own risk-sending the data through wide area networks to the single scanning tool can expose the sensitive data to pilfering by technically capable scoundrels who would misuse the data for their own nefarious ends.

### SUMMARY

In one aspect, a method for monitoring a file system within a distributed network is provided. From a local hosting environment having a native scanning tool, the method detects creation of a new data store within the network. Responsive to detecting creation of the new data store, the method determines whether the new data store is physically located within a foreign hosting environment that is communicatively coupled to the local hosting environment through a non-private network. Responsive to determining that the new data store is physically located within the foreign hosting environment, the method creates an agent of the native scanning tool within the foreign hosting environment and causes the agent to be applied to the new data store within the foreign hosting environment to obtain sensitivity information for the new data store. The method receives and records the sensitivity information for the new data store.

In some embodiments, the local hosting environment is a first cloud hosting environment, and the foreign hosting environment is either a second cloud hosting environment or an on-premise hosting environment.

In some embodiments, the local hosting environment having the native scanning tool is an on-premise hosting environment and the foreign hosting environment is a cloud hosting environment.

In some embodiments, detecting creation of a new data store within the network is carried out from within a subscription to services in the network. All other subscriptions to services within the network are identified. For each remote cloud hosting environment, a cloud hosting API for a hosting service hosting that remote cloud hosting environment is queried for a list of current data stores in that remote cloud hosting environment that are associated with the subscriptions. For each on-premise hosting environment, a preconfigured on-premise API is queried for a list of current data stores within the on-premise hosting environment that are associated with the subscriptions. The lists of current data stores are received and compared to a master list of recognized data stores to identify any data stores that are included in the lists of current data stores but absent from the master list of recognized master stores.

In some embodiments, creating an agent of the native scanning tool and applying the agent to the new data store to obtain sensitivity information for the new data store comprises running a scanning application on a virtual machine (VM) within the foreign hosting environment where the new data store is physically located to connect the VM to the native scanning tool, generating access credentials for the scanning application to access the new data store, providing the network location of the new data store to the native scanning tool, and causing the VM to access the new data store and run the scanning application against the new data store, and to report results of running the scanning application against the new data store to the native scanning tool.

In another aspect, a method for monitoring a file system within a distributed network is provided. The method detects creation of a new data store within the network. Responsive to detecting creation of the new data store, the method determines whether the new data store is familiar to a native scanning tool or unfamiliar to the native scanning tool. Responsive to determining that the new data store is familiar to the native scanning tool, the method deploys the native scanning tool upon the new data store. Responsive to determining that the new data store is unfamiliar to the native scanning tool, the method samples the new data store to obtain a sample file, then converts the sample file to obtain a converted sample file that is familiar to the native scanning tool, and then deploys the native scanning tool upon the converted sample file.

Sampling the new data store to obtain the sample file may comprise randomly selecting data elements from the data store.

The data store may be, for example, a static data store or a data stream.

In some embodiments, converting the sample file to obtain the converted sample file that is familiar to the native scanning tool comprises converting the sample file from its original format to JavaScript Object Notation (JSON). The original format may be, for example, a proprietary format or a standard format that remains unfamiliar to the particular native scanning tool.

In other aspects, the present disclosure is directed to computer program products and data processing systems for implementing the above-described methods.

### BRIEF DESCRIPTION OF THE DRAWINGS

These and other features will become more apparent from the following description in which reference is made to the appended drawings wherein:

FIG. 1 shows an illustrative distributed computer network in respect of which aspects of the present disclosure may be implemented;

FIG. 2 shows an illustrative server in respect of which aspects of the present disclosure may be implemented;

FIG. 3 is a flow chart showing an illustrative method for monitoring a file system within a distributed network according to an aspect of the present disclosure;

FIG. 4 is a flow chart showing an illustrative method for detecting creation of a new data store within a distributed network according to an aspect of the present disclosure;

FIG. 5 is a flow chart showing an illustrative method for causing a native scanning tool to directly scan a new data store to obtain sensitivity information for the new data store where the data store is located within a local host environment, according to an aspect of the present disclosure;

FIG. 6 is a flow chart showing an illustrative method for creating an agent of a native scanning tool and applying the agent to the new data store to obtain sensitivity information for the new data store, according to an aspect of the present disclosure;

FIG. 7 is a flow chart showing an illustrative method 700 for monitoring a file system within a distributed network, according to an aspect of the present disclosure;

FIG. 8 is a schematic representation of an illustrative distributed computer network showing application of methods according to aspects of the present disclosure; and

FIG. 9 is a sequence diagram showing actions, and the sequence of those actions, for each of an application console, a cloud platform for a local hosting environment, an orchestrator in the local hosting environment, a native scanning tool in the local hosting environment, and an SQL server, according to an aspect of the present disclosure.

### DETAILED DESCRIPTION

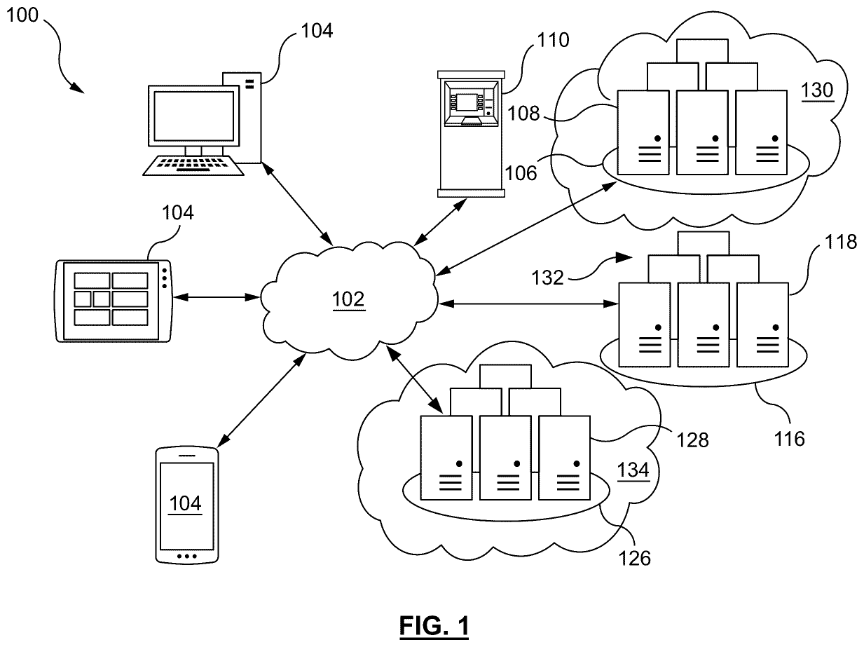

Referring now to FIG. 1, there is shown a distributed computer network 100. More particularly, the distributed computer network 100 comprises a wide area network 102 such as the public Internet to which various client devices 104, an automatic teller machine (ATM) 110, and first, second and third data centers 106, 116, 126 are communicatively coupled. The data centers 106, 116, 126 respectively comprise a number of servers 108, 118, 128 networked together to collectively perform various computing functions. The wide area network 102 is a non-private network, in that the wide area network 102 includes components that are under the control of parties other than the parties who control the data centers 106, 116, 126 whereby data transiting between the data centers 106, 116, 126 would potentially be exposed to parties other than the parties who control the data centers 106, 116, 126. Thus, a non-private network is distinguished from a private network (i.e. intranet) in which all of the network components are controlled by either a single entity, or by the entities that control the end nodes of the network. For greater clarity, the use of a virtual private network (VPN) to transit data through a non-private network does not cause that non-private network to become a private network.

As shown in FIG. 1, the first data center 106 is part of a first cloud hosting environment 130, the second data center 116 is an on-premise hosting environment 132, and the third data center 126 is part of a second cloud hosting environment 134. An on-premise hosting environment is one in which the company or other entity operates and controls the hardware infrastructure upon which the relevant software executes. A cloud hosting environment is one in which the company or other entity leases access to the hardware infrastructure from a third-party service provider. Examples of cloud hosting environments include Microsoft® Azure® offered by Microsoft Corporation, having an address at One Microsoft Way, Redmond, WA 98052-6399, USA and Amazon Web Services® (AWS®) offered by Amazon Technologies, Inc. having an address at 410 Terry Ave N, Seattle, WA 98109, USA.

Each of the data centers is a hosting environment which can host applications and data stores used by the applications. For example, in the context of a financial institution such as a bank, the data centers 106, 116, 126 may host aspects of online banking services that permit users to log in using user accounts that give them access to various computer-implemented banking services, such as online fund transfers. Furthermore, individuals may appear in person at the ATM 110 to withdraw money from bank accounts controlled by the on-premise hosting environment 132. The data centers 106, 116, 126 may communicate with one another through the wide area network 102.

As can be seen in FIG. 1, the data centers 106, 116, 126 do not communicate directly

with one another, but instead communicate with one another via the wide area network 102. Thus, with respect to the first cloud hosting environment 130, the on-premise hosting environment 132 and the second cloud hosting environment 134 are each a foreign hosting environment that is communicatively coupled to the first cloud hosting environment 130 through a non-private network 102. Similarly, with respect to the on-premise hosting environment 132, the first cloud hosting environment 130 and the second cloud hosting environment 134 are each a foreign hosting environment that is communicatively coupled to the on-premise hosting environment 132 through a non-private network 102. Likewise, with respect to the second cloud hosting environment 134, the first cloud hosting environment 130 and the on-premise hosting environment 132 are each a foreign hosting environment that is communicatively coupled to the second cloud hosting environment 134 through a non-private network 102. Thus, the term “foreign”, as used herein, refers to hosting environments which, although communicatively coupled, are communicatively coupled to one another through a non-private network 102, such as the public Internet, and not exclusively through a private intranet. Typically, each of the data centers 106, 116, 126 will be protected against unwanted intrusion by a firewall and/or other protective measures interposed between the respective data centers 106, 116, 126 and the wide area network 102. In one non-limiting embodiment, a cloud hosting environment is “foreign” to another cloud hosting environment if communication with that other cloud hosting environment must traverse an external firewall for that other cloud hosting environment.

Each hosting environment 130, 132, 134 may have a native scanning tool for directly scanning files within that hosting environment 130, 132, 134 to identify data and classify the data according to sensitivity. For example, in a Microsoft Azure cloud hosting environment, Microsoft Purview can provide a native scanning tool, or in an Amazon Web Services (AWS) cloud hosting environment, Amazon Macie® can provide a native scanning tool. Proprietary or third-party scanning tools may also be used as native scanning tools, depending on the particular cloud hosting environment. These are merely illustrative examples and is not limiting.

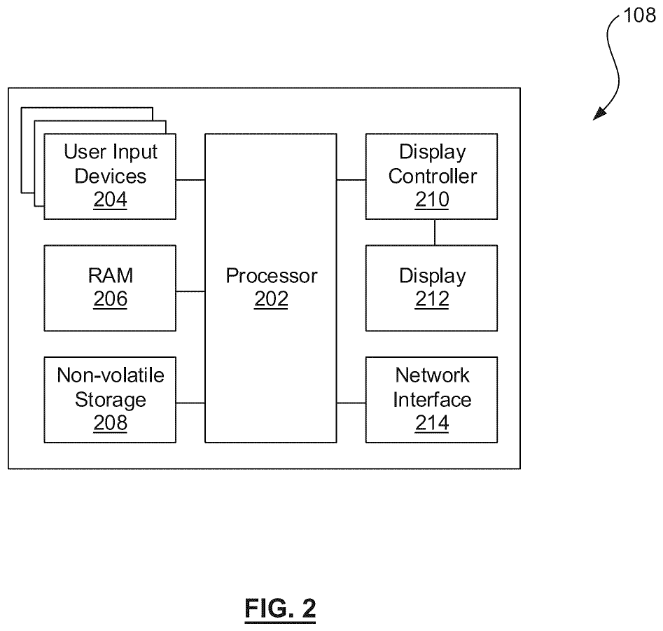

Referring now to FIG. 2, there is depicted an example embodiment of one of the

servers 108 that comprises the first data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the processor 202 at runtime; a display controller 210, which is communicatively coupled to and controls a display 212; and a network interface 214, which facilitates network communications with the wide area network 102 and the other servers 108 in the data center 106. The non-volatile storage 208 has stored thereon computer program code that is loaded into the RAM 206 at runtime and that is executable by the processor 202. Additionally or alternatively, the servers 108 may collectively perform various functions using distributed computing. While the system depicted in FIG. 2 is described specifically in respect of one of the servers 108, analogous versions of the system may also be used for the servers 118, 128 and the client devices 104.

The servers 108, 118, 128 in one of the respective data centers 106, 116, 126 may implement a method for monitoring a file system within a distributed network.

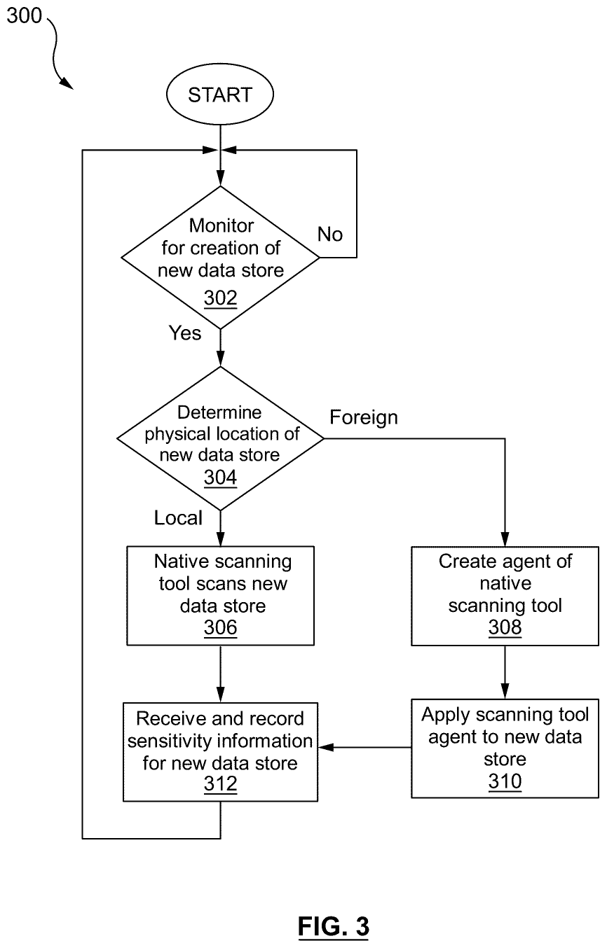

Reference is now made to FIG. 3, which is a flow chart 300 showing an illustrative method for monitoring a file system within a distributed network, such as the distributed network 100 shown in FIG. 1. The method 300 is carried out from a local hosting environment. Typically, the local hosting environment will be protected, for example a software firewall and/or a hardware firewall, from unauthorized access via the non-private network 102, and is therefore a protected hosting environment. The local hosting environment may be, for example an on-premise hosting environment, such as on-premise hosting environment 132, or a cloud hosting environment, such as either the first cloud hosting environment 130, or the second cloud hosting environment 134.

The local hosting environment has a native scanning tool, that is, a data tool that is adapted to scan data stores within the local hosting environment (e.g. Microsoft Purview can provide a native scanning tool for a Microsoft Azure hosting environment, and AWS Macie can provide a native scanning tool for an AWS hosting environment.). Thus, the term “local hosting environment” refers to the hosting environment in which the native scanning tool resides, that is, within which the native scanning tool can operate without an external network connection. Accordingly, if the native scanning tool resides in either the first cloud hosting environment 130, or the second cloud hosting environment 134, that cloud hosting environment would be the “local hosting environment”, even though it is remote from the on-premise hosting environment 132.

At step 302, the method 300 monitors for creation of a new data store within the network. If no new data store is detected (“no” at step 302), step 302 repeats, i.e. the method 300 continues to monitor for creation of a new data store within the network until one is detected. Responsive to detecting creation of a new data store (“yes” at step 302), the method 300 proceeds to step 304. At step 304, the method 300 determines whether the new data store is physically located within the local hosting environment, or whether the new data store is physically located within a foreign hosting environment that is communicatively coupled to the local hosting environment through a non-private network. For example, in some embodiments an AWS RDS PostgreSQL data source may be created; this data source would be physically located within the AWS hosting environment, which, depending on the context, may be a local hosting environment or a foreign hosting environment. More particularly, the hardware which hosts the data source is behind the AWS firewall. This is merely a non-limiting, illustrative example. For example, with reference to FIG. 1, the local hosting environment may be the first cloud hosting environment 130 and the foreign hosting environment may be the second cloud hosting environment 134 or the on-premise hosting environment 132. Or, the local hosting environment may be the on-premise hosting environment 132 and the foreign hosting environment may be a cloud hosting environment, such as either the first cloud hosting environment 130, or the second cloud hosting environment 134. These are merely illustrative examples and are not limiting.

Reference is again made to FIG. 3. Responsive to determining that the new data store is physically located within the local hosting environment (“local” at step 304), at step 306 the method 300 causes the native scanning tool to directly scan the new data store within the local hosting environment to obtain sensitivity information for the new data store. The sensitivity information comprises classifications of the data that is stored within the data store, based on the definitions (e.g. column headings, metadata or explicit classification tags) for that data store. For example, one type of classification relates to personally identifying information (PII), which is information about an identifiable individual. Within PII, there may be subclasses, such as general PII (e.g. name and address), sensitive PII (e.g. date of birth) and highly sensitive PII (e.g. social insurance number/social security number, or financial account information). Another example would be in the context of cryptocurrency, where a public key may be categorized as non-sensitive, information about types and quantities of cryptocurrency held would be categorized as sensitive, and private key information would be categorized as highly sensitive. These are merely non-limiting examples of sensitivity information. The term “sensitivity information” encompasses a wide range of sensitivity levels, classified with varying levels of granularity. Of note, the “sensitivity information” is information about the data that is stored within the data store, and not the data itself.

Alternatively, responsive to determining that the new data store is physically located within the foreign hosting environment (“foreign” at step 304), the method 300 proceeds to step 308. As step 308, the method 300 causes an agent of the native scanning tool to be created within the foreign hosting environment. Then, at step 310, the method 300 causes the agent to be applied to the new data store within the foreign hosting environment to obtain sensitivity information for the new data store. By creating the agent of the native scanning tool within the foreign hosting environment to effectuate the scan, rather than sending the data back to the local hosting environment to be scanned, the method 300 avoids sending any of the data in the data store through a non-private network (e.g. wide area network 102) where it might be intercepted by malefactors, or by miscreants. Thus, the sensitivity information about the data in the new data store can be provided in the local hosting environment while the data itself remains safely in the foreign hosting environment (e.g. behind a firewall).

In either case, after step 306 (directly scanning the new data store within the local hosting environment) or step 310 (applying the agent to the new data store within the foreign hosting environment), the method 300 proceeds to step 312 to receive and record the sensitivity information for the new data store in the local hosting environment.

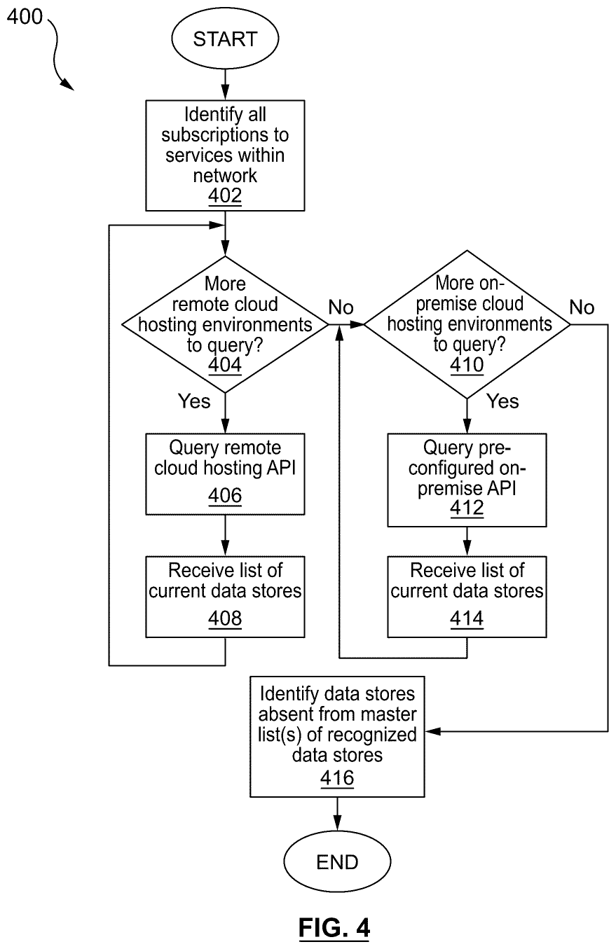

Reference is now made to FIG. 4, which is a flow chart that shows an illustrative method 400 for detecting creation of a new data store within the network (e.g. network 100 in FIG. 1). Thus, the method 400 shown in FIG. 4 is an illustrative implementation of step 302 of the method 300 shown in FIG. 3. The method 400 may be performed periodically, e.g. daily, twice daily, hourly, every four hours, among other periods. No limitation as to period is implied.

At step 402, the method 400 identifies all subscriptions to services within the network. A subscription refers to an administrative unit of resources for a cloud environment, such as an Azure subscription, an AWS account, or an OpenShift® namespace (OpenShift cloud services are offered by Red Hat, Inc. having an address at 100 East Davie Street, Raleigh, NC 27601, USA), by way of non-limiting example. This may be done, for example, using the API for the hosting environment, for example the Azure API or the AWS API in the case of a cloud hosting environment, or a purpose-built API for an on-premise hosting environment.

The subscription for the application environment within which the method 400 executes need not be explicitly identified, as it is inherently known and hence identification for that subscription is inherent.

In the illustrated embodiment, the method 400 begins by checking cloud hosting environments (as opposed to on-premise environments); in other embodiments this order may be reversed. More particularly, at step 404, the method 400 checks whether there are more remote cloud hosting environments to query. Responsive to determining that there are more remote cloud hosting environments to query (“yes” at step 404), the method proceeds to step 406 and queries the cloud hosting application programming interface (API) for the next remote cloud hosting environment. The query may make use of the AWS API or the Azure API for those respective environments, by way of non-limiting example. In some embodiments, a bespoke query may be constructed. The query at step 406 is for a list of current data stores in that remote cloud hosting environment that are associated with the subscriptions. The query will be dependent on the system environment, and implementation of a suitable query is within the capability of one of ordinary skill in the art, now informed by the present disclosure. At step 408, the method 400 receives the list of current data stores, and then returns to step 404. Thus, via steps 404 through 408, the method 400 will, for each remote cloud hosting environment, query the cloud hosting API for the hosting service hosting that remote cloud hosting environment for a list of current data stores in that remote cloud hosting environment that are associated with the subscriptions, and receive the lists of current data stores in the remote cloud environments. Once all remote cloud environments have been queried (“no” at step 404), the method 400 proceeds to step 410. If it is known that there is only a single remote cloud environment, step 404 may be omitted and the method 400 may proceed from step 408 to step 410.

At step 410, the method 400 checks whether there are more on-premise hosting environments to query. Responsive to determining that there are more on-premise hosting environments to query (“yes” at step 410), the method proceeds to step 412 and queries the preconfigured on-premise API for the next on-premise hosting environment. The query at step 412 is for a list of current data stores in that on-premise hosting environment that are associated with the subscriptions. The query may be similar to that described above. At step 414, the method 400 receives the list of current data stores, and then returns to step 410 to check whether there are more on-premise hosting environments to query. Thus, via steps 410 through 414, the method 400 will, for each on-premise hosting environment, query the preconfigured on-premise API for that on-premise hosting environment for a list of current data stores in that on-premise hosting environment that are associated with the subscriptions, and receive the lists of current data stores in the on-premise environments. Once all on-premise environments have been queried (“no” at step 410), the method 400 proceeds to step 416. If it is known that there is only a single on-premise environment, step 410 may be omitted and a “no” at step 404 may proceed directly to step 412.

Steps 404 through 408, and steps 410 through 414, respectively, may be performed in the reverse order, or substantially simultaneously. If it is known that there is only a single remote cloud environment and only a single on-premise environment, steps 404 and 410 may be omitted and the method 400 may proceed from step 408 to step 412.

At step 416, the method 400 compares the received lists of current data stores (from steps 408 and 414) to a master list of recognized data stores to identify any data stores that are included in the lists of current data stores but absent from the master list of recognized master stores. The data stores that are included in the lists of current data stores but absent from the master list are thus detected as newly created data stores. The term “master list” does not imply a single monolithic list; more than one individual list may combine to form an overall master list.

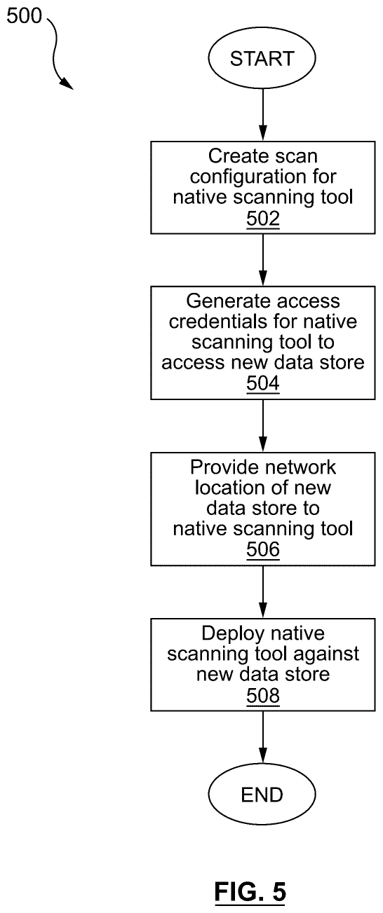

Reference is now made to FIG. 5, which is a flow chart that shows an illustrative method 500 for causing the native scanning tool to directly scan a new data store to obtain sensitivity information for the new data store where the data store is located within a local host environment or other directly scannable hosting environment. The method 500 may be used where the new data store is in a Microsoft Azure cloud hosting environment, where Microsoft Purview can provide a native scanning tool. The method 500 in FIG. 5 is an illustrative, non-limiting implementation of step 306 of the method 300 shown in FIG. 3.

At step 502, the method 500 creates a scan configuration for the native scanning tool, and at step 504 the method 500 generates access credentials for the native scanning tool to access the new data store. Each data store will have a different way to authenticate scanning tools. For example, for an Azure Cloud, Managed Identity may be used, or where there is a username/password for the data store, this can be provided to the scanning tool so that the scanning tool can authenticate against the data store. The application implementing the method 500 will preferably manage the authentication credentials so that the scanning tool can read the required data from the data store to implement the scan. At step 506, the method 500 provides a network location of the new data store to the native scanning tool, and at step 508 the method 500 deploys the native scanning tool against the new data store. In a Microsoft Azure cloud hosting environment, a Managed Private End Point (MPEP) may be used to securely communicate with the native scanning tool; a storage account is supported by Microsoft Purview and for an Azure SQL server, custom logic may be used to grant the required permission(s) to Microsoft Purview via Managed Identity. Other techniques may also be used, such as username/password, or access tokens, without limitation.

Implementation of such techniques is within the capability of one of ordinary skill in the art, no informed by the present disclosure. Steps 502, 504 and 506 may be performed in a different order.

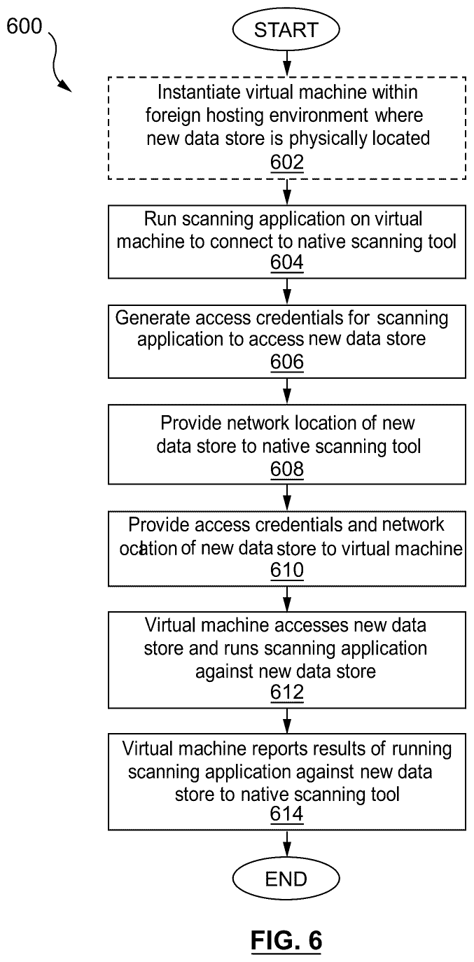

Reference is now made to FIG. 6, which is a flow chart that shows an illustrative method 600 for creating an agent of the native scanning tool and applying the agent to the new data store to obtain sensitivity information for the new data store. The method 600 may be used in the context of a foreign hosting environment. For example, if the local hosting environment is a Microsoft Azure cloud hosting environment, the method 600 may be deployed where the data store does not support Azure Purview Integration Runtime

Applications. The integration runtime (IR) is the compute infrastructure that Microsoft Purview uses to power data scan across different network environments. A self-hosted integration runtime (SHIR) can be used to enable Purview to scan a data store in an on-premise hosting environment or a cloud hosting environment other than a Microsoft Azure cloud hosting environment. An agent (SHIR in the case of Purview) can scan a data store in an on-premise environment (or a non-Azure cloud hosting environment) and only send the metadata information to the Purview instance in the Azure cloud hosting environment, without sending actual data from the data store outside of the on-premise environment (or the non-Azure cloud hosting environment). Broadly speaking, a scanning tool can store metadata and classification information for the data store being scanned but should execute the scan without exfiltrating the data from the foreign hosting environment in which the data store is physically located. The foreign hosting environment may be, for example, an on-premise hosting environment or an AWS hosting environment. Azure and Purview are provided as a non-limiting illustrative example.

At optional step 602, where a scan is being run in the foreign hosting environment for the first time, the method 600 instantiates a virtual machine (VM) within the foreign hosting environment where the new data store is physically located. Step 602 may be omitted when the VM is already instantiated in the foreign hosting environment. At step 604 the method 600 runs a scanning application on the VM to connect the VM to the native scanning tool (e.g. SHIR in the case of Purview). At step 606 the method 600 generates access credentials for use by the scanning application to access the new data store and at step 608 the method 600 provides the network location (e.g. a URL or IP address) of the new data store to the native scanning tool. Steps 606 and 608 may be performed in any order, or substantially simultaneously. At step 610, the method 600 provides the access credentials and the network location of the new data store to the VM. For example, the native scanning tool may securely transmit the access credentials and the network location to the scanning tool that is acting as the agent of the native scanning application. Then, at step 612 of the method 600, the method 600 causes the VM to access the new data store and run the scanning application against the new data store. Finally, at step 614, the VM will report the results of running the scanning application against the new data store to the native scanning tool, which receives the results.

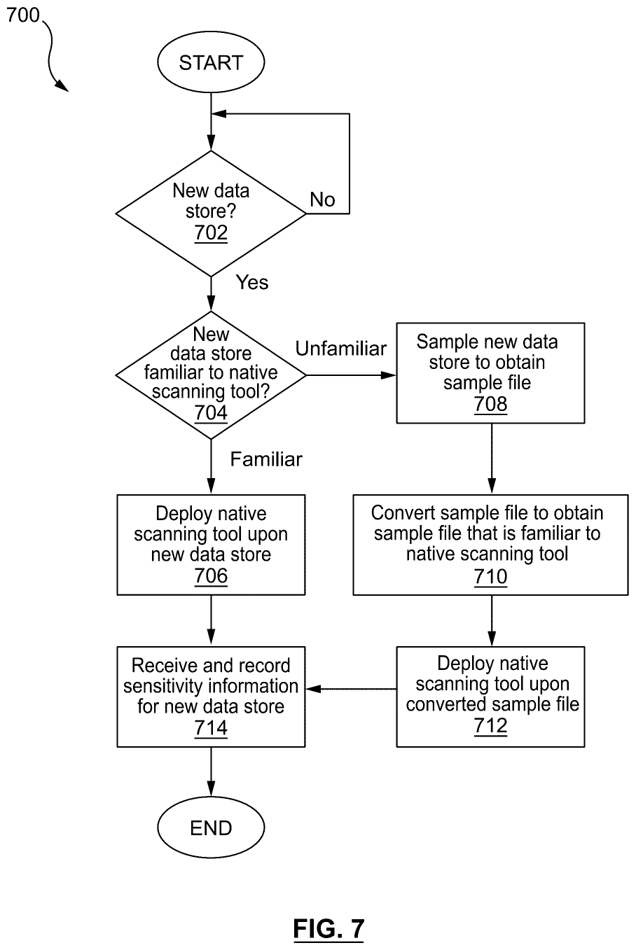

FIG. 7 is a flow chart showing an illustrative method 700 for monitoring a file system within a distributed network, such as the network 100 shown in FIG. 1. At step 702, the method 700 monitors for creation of a new data store within the network. The data store may be, for example, a static data store or a data stream. If no new data store is detected (“no” at step 702), step 702 repeats, i.e. the method 700 continues to monitor for creation of a new data store within the network until one is detected. Detection of creation of a new data store may be effectuated, for example, using the method 400 shown in FIG. 4.

If a new data store is detected (“yes” at step 702), then in response to detecting creation of the new data store, the method 700 proceeds to step 704. At step 704, the method 700 determines whether the new data store is familiar to the native scanning tool for the environment from which the method 700 originates (e.g. Purview in a Microsoft Azure environment) or unfamiliar to the native scanning tool. A data store will be familiar to a native scanning tool if it is in a format that is scannable by the native scanning tool, and will be unfamiliar to the native scanning tool if it is in a format that cannot be directly scanned by the native scanning tool. For example, that data store may be in an original format is a proprietary format, or in a standard format that remains unfamiliar to the particular native scanning tool. For example, if a native scanning tool can scan JSON and CSV files, but not bitmap or DBF files, then a data store having JSON or CSV files will be familiar and a data having bitmap or DBF files will be unfamiliar. In the latter case, a tool can be provided to sample bitmap and/or DBF files and convert them into JSON or CSV files. Implementation of such a tool is within the capability of one of ordinary skill in the art, now informed by the present disclosure. The foregoing are merely non-limiting, illustrative examples.

Responsive to determining that the new data store is familiar to the native scanning tool (“familiar” at step 704), the method 700 proceeds to step 706 and deploys the native scanning tool upon the new data store. Responsive to determining that the new data store is unfamiliar to the native scanning tool (“unfamiliar” at step 704), the method 700 proceeds to steps 708 through 712. At step 708 the method 700 samples the new data store to obtain a sample file, for example by randomly selecting data elements from the data store. Then, at step 710, the method 700 converts the sample file to obtain a converted sample file that is familiar to the native scanning tool. In a preferred embodiment, conversion may be effected by converting the sample file from an original format to JavaScript Object Notation (JSON) although this is merely one illustrative example. Then, at step 712, the method 700 deploys the native scanning tool upon the converted sample file. The method 700 may be carried out by a custom-built conversion tool, which may be configured to recognize data stores (including data streams) and formats that are not recognized by the native scanning tool, and then execute a suitable format conversion process to present the sample file in a format that is recognized by the native scanning tool. Using a sample of the data store reduces the processing load, particularly for large data stores, and is usually sufficient to obtain the required sensitivity information.

After deployment of the native scanning tool at either step 706 (“familiar”) or step 712 (“unfamiliar”), the method 700 proceeds to step 714 to receive and record the sensitivity information for the new data store.

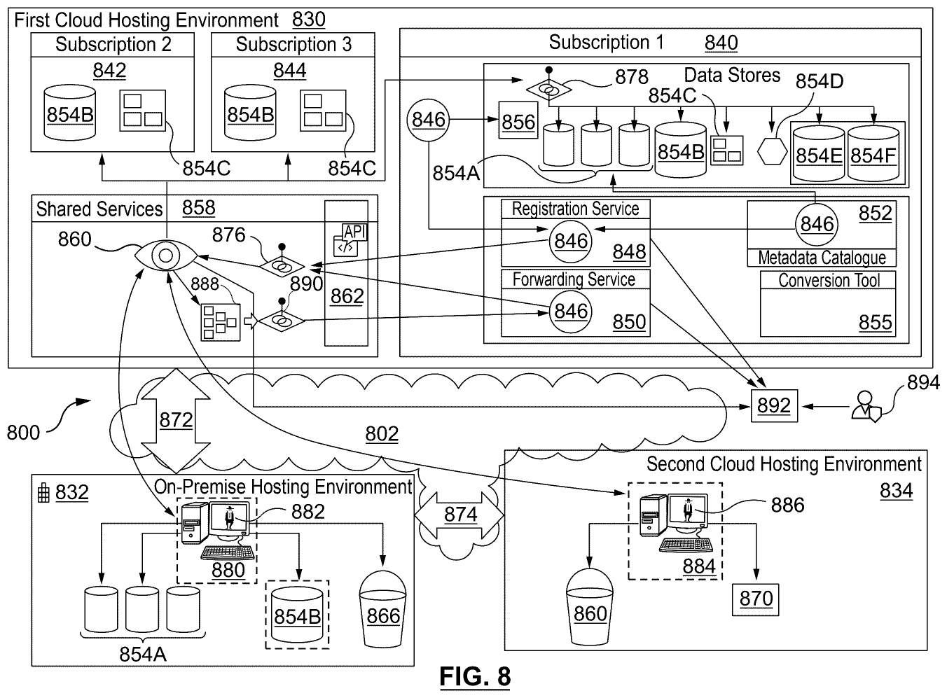

Reference is now made to FIG. 8, which is a schematic representation of an illustrative distributed computer network 800 showing application of some of the above-described methods. The network 800 shown in FIG. 8 comprises a wide area network 802 (e.g. the public Internet) that is a non-private network. The network 800 further comprises a first cloud hosting environment 830, an on-premise hosting environment 832, and a second cloud hosting environment 834. In the illustrated embodiment, the first cloud hosting environment 830 is a Microsoft Azure hosting environment for which Purview provides a native scanning tool 860 and the second cloud hosting environment 834 is an AWS hosting environment. The first cloud hosting environment 830, the on-premise hosting environment 832, and the second cloud hosting environment 834 may communicate with one another indirectly through the wide area network 802.

An embodiment will now be described in which the first cloud hosting environment 830 is the local hosting environment, relative to which the on-premise hosting environment 832 and the second cloud hosting environment 834 are each a foreign hosting environment that is communicatively coupled to the first cloud hosting environment 830 through the non-private wide area network 802.

Within the first cloud hosting environment 830 are a plurality of subscriptions, including a first subscription 840, a second subscription 842 and a third subscription 844. The first subscription 840 will now be described in greater detail.

The first subscription 840 includes a containerized platform API 846, which facilitates communication with various components within the first subscription 840, including a registration service 848, a forwarding service 850, a metadata catalogue 852, and a plurality of data stores 854A . . . 854F. The data stores include application databases 854A (e.g. SQL databases) managed by an SQL server 856, one or more data lakes 854B, one or more blob storage 854C, one or more Azure files 854D, one or more PostgreSQL storage 854E and one or more MongoDB storage 854F. The SQL server 856 may also manage the data lake(s) 854B, blob storage 854C, Azure file(s) 854D, PostgreSQL storage 854E and/or MongoDB storage 854F. These are merely illustrative examples and are not limiting; a subscription need not have all of the foregoing types of data stores, or may have additional types of data stores. The second subscription 842 and the third subscription 844 also include data stores; these are shown as data lakes 854B and blob storage 854C merely for purposes of illustration; the second subscription 842 and the third subscription 844 may have different, fewer or additional data stores.

In addition, a conversion tool 855 for executing the method 700 in FIG. 7 may also be deployed within the first subscription 840.

The first cloud hosting environment 830 also hosts shared services 858, which include the native scanning tool 860. In the illustrated embodiment where the first cloud hosting environment 830 is a Microsoft Azure hosting environment, the native scanning tool 860 is

Purview and access to the shared services 858 is provided by an Azure remote hosting API 862. This is merely an example and is not limiting.

The on-premise hosting environment 832 also includes on-premise data stores; these are shown as SQL databases 854A, as well as an SQL database 854A executing on a virtual machine and a Simple Storage Service (S3) compatible local storage 866. These are merely illustrative examples and are not limiting; the on-premise hosting environment 832 need not have all of the foregoing types of data stores, or may have additional types of data stores.

The data stores for the second cloud hosting environment 834 include an S3 bucket 868 and a Microsoft SQL instance 870; again, these are non-limiting, illustrative examples and the second cloud hosting environment 834 may have more, fewer, and/or different data stores.

The on-premise hosting environment 832 may communicate through the network 802 with the first cloud hosting environment 830 via an ExpressRoute connection 872, and may communicate through the network 802 with the second cloud hosting environment 834 via an AWS Direct Connect connection 874. The on-premise hosting environment 832 and the second cloud hosting environment 834 may each be provided with their own respective API(s) to facilitate communication.

In the illustrated embodiment, within the first subscription 840 the containerized platform API 846 facilitates communication with the SQL server 856 to set up database access. SQL columns, from which sensitivity classifications may be obtained, are read from the application databases 854A and stored in the metadata catalogue 852. Updates may be sent from the metadata catalogue 852 to the registration service 848, which may update search parameters (e.g. Purview glossary terms).

The registration service 848 detects creation of new data stores (e.g. step 302 in FIG. 3, step 702 in FIG. 7, method 400 in FIG. 4). The registration service 848 also obtains specified sensitivity classification from the SQL columns provided by the metadata catalogue 852; these may later be compared to the results from the native scanning tool 860.

In addition, the registration service 848 sets up the scan job for the native scanning tool 860. For example, where the first cloud hosting environment 830 is a Microsoft Azure hosting environment and the native scanning tool 860 is Microsoft Purview, the registration service 848 may trigger a call to an Atlas API; the Microsoft Purview Data Catalog is based on Apache Atlas and extends full support for Apache Atlas APIs. In such an embodiment, the registration service 848 may add a collection, add a data set or database, upload custom classifications, set up scan rules and scan triggers (e.g. a scheduled scan frequency), and update sensitivity classifications using, for example, Purview glossary terms. The forwarding service 850 may provide the query glossary terms for SQL column sensitivity label information. The registration service 848 and the forwarding service 850 may communicate with the shared services 858 via the Azure remote hosting API 862 and a connection link 876 (e.g. in a Microsoft environment, this may be an MPEP). The native scanning tool 860 then executes the scan jobs.

Preferably, the process is implemented at scheduled times, so that new data stores can be detected and scanned. Also preferably, the method scans not only new data stores but all data stores, so as to detect sensitivity information arising from changes to existing data stores.

Within the first cloud hosting environment 830, the native scanning tool 860 uses another connection point 878 to scan the data stores 854A . . . 854F in the first subscription 840, and similarly scans the data stores 854B, 854C in the second subscription 842 and the third subscription 844. If the data stores are determined to be familiar to the native scanning tool 860, the native scanning tool 860 is deployed directly upon the new data store(s). For any of the data stores that are determined to be unfamiliar to the native scanning tool, the data store may be sampled to obtain a sample file, which is then converted to a format that is familiar to the native scanning tool 860, which is then deployed upon the converted sample file.

Because the first cloud hosting environment 830 is a local hosting environment with respect to the native scanning tool 860, it is not necessary to create an agent of the native scanning tool.

The on-premise hosting environment 832 and the second cloud hosting environment 834, however, are foreign hosting environments relative to the native scanning tool 860.

Therefore, if it is determined that a new data store is physically located within the on-premise hosting environment 832 or the second cloud hosting environment 834, an agent of the native scanning tool 860 is created within that environment.

For example, for the on-premise hosting environment 832, a self-hosted integration runtime (SHIR) may be run in a Microsoft Windows® container on a VM 880 instantiated in the on-premise hosting environment 832, and a scanning application 882 is installed on the VM 880 to connect the VM to the native scanning tool 860. The scanning application 882 functions as an agent of the native scanning tool 860. Access credentials are generated for the scanning application 882 to access the new data store (e.g. one of the SQL databases 854A, one or more of which may run on another VM in the on-premise hosting environment 832) and the network location of the new data store is provided to the native scanning tool 860. The VM 880 accesses the new data store and runs the scanning application 882 against the new data store (e.g. SHIR for Purview). The results of running the scanning application 882 against the new data store are then reported to the native scanning tool 860.

Similarly, where the second cloud hosting environment 834 is an AWS environment, a SHIR may run in an Amazon EC2® (Elastic Compute Cloud) VM 884 instantiated in the second cloud hosting environment 834. A scanning application 886, which functions as an agent of the native scanning tool 860, is installed on the VM 884 to connect the VM to the native scanning tool 860. Access credentials are generated for the scanning application 886 to access the new data store (e.g. S3 bucket 868 or Microsoft SQL instance 870), either of which may run on another VM in the second cloud hosting environment 834. The network location of the new data store is provided to the native scanning tool 860. The VM 884 accesses the new data store and runs the scanning application 886 against the new data store, with the results reported back to the native scanning tool 860.

After the scans are complete, the native scanning tool 860 assembles the results (“events”) and transmits them to an event hub 888 (e.g. Atlas EventHub), from which the events can be communicated via a connection point 890 to the forwarding service 850, which can communicate relevant information from the events to an application console 892, for example a Splunk® Monitoring Console, offered by Splunk Inc., having an address at 270 Brannan Street, San Francisco, CA 94107, USA. The information communicated by the forwarding service 850 to the application console 892 may include sensitivity information such as PII being detected in “sensitive” information or “classified” information, or where a detected sensitivity classification is higher than what was declared for the data store. The native scanning tool 860 may also communicate diagnostic logs (e.g. a failed scan) to the application console 892; the registration service 848 may also communicate with the application console 892. Security personnel 894 may access the application console 892, and may receive alerts therefrom for events of particular significance, for example by text, e-mail, pager or phone.

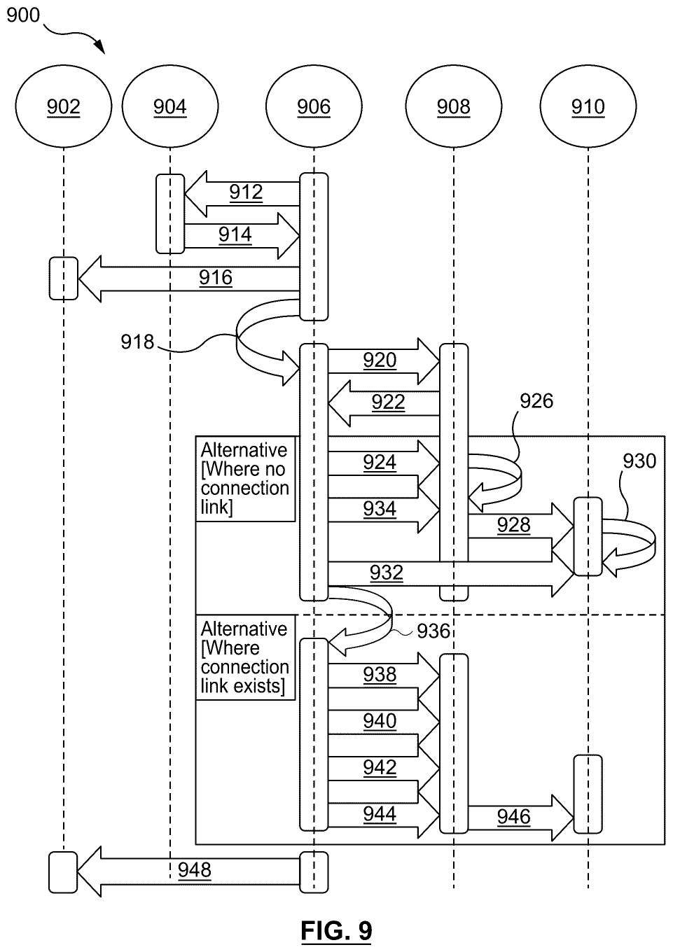

Reference is now made to FIG. 9, which is an illustrative, non-limiting sequence diagram 900, showing actions, and the sequence of those actions, for each of an application console 902 (e.g. a Splunk Monitoring Console), a cloud platform 904 (e.g. Azure) for a local hosting environment, an orchestrator 906 (e.g. an overarching application administering the methods described herein) in the local hosting environment, a native scanning tool 908 (e.g. Microsoft Purview) in the local hosting environment, and an SQL server 910. The orchestrator 906 provides a layer of abstraction on top of underlying infrastructure technologies.

The orchestrator 906 sends a request 912 to the cloud platform 904 for a list of all databases in the cloud platform 904, and receives a response 914 listing all of the SQL databases in the cloud platform 904. The orchestrator 906 generates a list of all unregistered databases, which is sent 916 to the application console 902, and then onboards 918 all of the unregistered databases. The orchestrator 906 sends a request 920 to the native scanning tool 908 for a list of all connection points, and then receives the list 922.

Where no connection point exists, the orchestrator 906 requests 924 that the native scanning tool 908 create a connection point, responsive to which the native scanning tool 908 provisions 926 the connection point and creates 928 the connection point for the SQL server 910, which in turn creates 930 a private end point (PEP), which is approved 932 by the orchestrator 906.

The orchestrator 906 periodically checks 934 whether the connection point is pending approval, or has been approved 936. Once the connection point is approved 936, or if the connection point already exists, the orchestrator 906 sends instructions to the native scanning tool 908 to add a credential 938 (to access the data store), add metadata or administrative data 940, add a data store 942 and add a scheduled scan 944 for that data store. The native scanning tool 908 then communicates with the SQL server 910 to scan and classify the data 946 based on the schedule.

If there is any error during the onboarding 918, the orchestrator 906 sends a log 948 to the application console 902.

While reference has been made to certain non-limiting cloud platforms for purposes of illustration, the technology described herein is not limited to those platforms. For example, it is contemplated that the technology may be applied in the context of other cloud platforms, including but not limited to Google Cloud offered by Google LLC having an address at 1600 Amphitheatre Parkway, Mountain View, CA 94043, USA and Rumble Cloud Services, offered by Rumble, Inc./Rumble Cloud USA Inc. having an address at 444 Gulf of Mexico Drive, Longboat Key, FL 34228, USA, among others.

As can be seen from the above description, the file system monitoring technology described herein represents significantly more than merely using categories to organize, store and transmit information and organizing information through mathematical correlations. There is in fact an improvement to the technology file system monitoring technology, as aspects of the present disclosure avoid sending any of the data in a potentially sensitive data store through a non-private network where it might be intercepted. This enables the sensitivity information about the data in the data store to be provided in the local hosting environment while the data itself remains safely in the foreign hosting environment. Additional aspects allow a native scanning tool to handle data stores having unfamiliar formats. Moreover, the file system monitoring technology described herein is confined to distributed computer network applications.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network or a wide area network, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprise”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the invention as defined in the claims.

What is claimed is:

1. A method for monitoring a file system within a distributed network, the method comprising:
from a local hosting environment having a native scanning tool:
detecting creation of a new data store within the network;
responsive to detecting creation of the new data store, determining whether the new data store is physically located within a foreign hosting environment that is communicatively coupled to the local hosting environment through a non-private network;
responsive to determining that the new data store is physically located within the foreign hosting environment, creating an agent of the native scanning tool within the foreign hosting environment and causing the agent to be applied to the new data store within the foreign hosting environment to obtain sensitivity information for the new data store; and
receiving and recording the sensitivity information for the new data store.

2. The method of claim 1, wherein the local hosting environment is a first cloud hosting environment and wherein the foreign hosting environment is one of:
a second cloud hosting environment; and
an on-premise hosting environment.

3. The method of claim 1, wherein the local hosting environment having the native scanning tool is an on-premise hosting environment and wherein the foreign hosting environment is a cloud hosting environment.

4. The method of claim 1, wherein detecting creation of a new data store within the network comprises:
from within a subscription, identifying all other subscriptions to services within the network;
for each remote cloud hosting environment, querying a cloud hosting API for a hosting service hosting that remote cloud hosting environment for a list of current data stores in that remote cloud hosting environment that are associated with the subscriptions;
for each on-premise hosting environment, querying a preconfigured on-premise API for a list of current data stores within the on-premise hosting environment that are associated with the subscriptions; and
receiving the lists of current data stores; and
comparing the received lists of current data stores to a master list of recognized data stores to identify any data stores that are included in the lists of current data stores but absent from the master list of recognized master stores.

5. The method of claim 1, wherein creating an agent of the native scanning tool and applying the agent to the new data store to obtain sensitivity information for the new data store comprises:
running a scanning application on a virtual machine (VM) within the foreign hosting environment where the new data store is physically located to connect the VM to the native scanning tool;
generating access credentials for the scanning application to access the new data store;
providing the network location of the new data store to the native scanning tool; and
causing the VM to:
access the new data store and run the scanning application against the new data store; and
report results of running the scanning application against the new data store to the native scanning tool.

6. A computer program product comprising at least one tangible, non-transitory computer-readable medium embodying instructions which, when executed by at least one processor of a data processing system, cause the data processing system to carry out a method for monitoring a file system within a distributed network, the method comprising:
from a local hosting environment having a native scanning tool:
detecting creation of a new data store within the network;
responsive to detecting creation of the new data store, determining whether the new data store is physically located within a foreign hosting environment that is communicatively coupled to the local hosting environment through a non-private network;
responsive to determining that the new data store is physically located within the foreign hosting environment, creating an agent of the native scanning tool within the foreign hosting environment and causing the agent to be applied to the new data store within the foreign hosting environment to obtain sensitivity information for the new data store; and
receiving and recording the sensitivity information for the new data store.

7. The computer program product of claim 6, wherein the local hosting environment is a first cloud hosting environment and wherein the foreign hosting environment is one of:
a second cloud hosting environment; and
an on-premise hosting environment.

8. The computer program product of claim 6, wherein the local hosting environment having the native scanning tool is an on-premise hosting environment and wherein the foreign hosting environment is a cloud hosting environment.

9. The computer program product of claim 6, wherein detecting creation of a new data store within the network comprises:
from within a subscription, identifying all other subscriptions to services within the network;
for each remote cloud hosting environment, querying a cloud hosting API for a hosting service hosting that remote cloud hosting environment for a list of current data stores in that remote cloud hosting environment that are associated with the subscriptions;
for each on-premise hosting environment, querying a preconfigured on-premise API for a list of current data stores within the on-premise hosting environment that are associated with the subscriptions; and
receiving the lists of current data stores; and
comparing the received lists of current data stores to a master list of recognized data stores to identify any data stores that are included in the lists of current data stores but absent from the master list of recognized master stores.

10. The computer program product of claim 6, wherein creating an agent of the native scanning tool and applying the agent to the new data store to obtain sensitivity information for the new data store comprises:
running a scanning application on a virtual machine (VM) within the foreign hosting environment where the new data store is physically located to connect the VM to the native scanning tool;
generating access credentials for the scanning application to access the new data store;
providing the network location of the new data store to the native scanning tool; and
causing the VM to:
access the new data store and run the scanning application against the new data store; and
report results of running the scanning application against the new data store to the native scanning tool.

11. A data processing system comprising at least one processor and a memory storing instructions which, when executed by the at least one processor, cause the data processing system to carry out a method for monitoring a file system within a distributed network, the method comprising:
from a local hosting environment having a native scanning tool:
detecting creation of a new data store within the network;
responsive to detecting creation of the new data store, determining whether the new data store is physically located within a foreign hosting environment that is communicatively coupled to the local hosting environment through a non-private network;
responsive to determining that the new data store is physically located within the foreign hosting environment, creating an agent of the native scanning tool within the foreign hosting environment and causing the agent to be applied to the new data store within the foreign hosting environment to obtain sensitivity information for the new data store; and
receiving and recording the sensitivity information for the new data store.

12. The data processing system of claim 11, wherein the local hosting environment is a first cloud hosting environment and wherein the foreign hosting environment is one of:
a second cloud hosting environment; and
an on-premise hosting environment.

13. The data processing system of claim 11, wherein the local hosting environment having the native scanning tool is an on-premise hosting environment and wherein the foreign hosting environment is a cloud hosting environment.

14. The data processing system of claim 11, wherein detecting creation of a new data store within the network comprises:
from within a subscription, identifying all other subscriptions to services within the network;
for each remote cloud hosting environment, querying a cloud hosting API for a hosting service hosting that remote cloud hosting environment for a list of current data stores in that remote cloud hosting environment that are associated with the subscriptions;
for each on-premise hosting environment, querying a preconfigured on-premise API for a list of current data stores within the on-premise hosting environment that are associated with the subscriptions; and
receiving the lists of current data stores; and
comparing the received lists of current data stores to a master list of recognized data stores to identify any data stores that are included in the lists of current data stores but absent from the master list of recognized master stores.

15. The data processing system of claim 11, wherein creating an agent of the native scanning tool and applying the agent to the new data store to obtain sensitivity information for the new data store comprises:
running a scanning application on a virtual machine (VM) within the foreign hosting environment where the new data store is physically located to connect the VM to the native scanning tool;
generating access credentials for the scanning application to access the new data store;
providing the network location of the new data store to the native scanning tool; and
causing the VM to:
access the new data store and run the scanning application against the new data store; and
report results of running the scanning application against the new data store to the native scanning tool.

16. A method for monitoring a file system within a distributed network, the method comprising:
detecting creation of a new data store within the network;
responsive to detecting creation of the new data store, determining whether the new data store is familiar to a native scanning tool or unfamiliar to the native scanning tool;
responsive to determining that the new data store is familiar to the native scanning tool, deploying the native scanning tool upon the new data store; and
responsive to determining that the new data store is unfamiliar to the native scanning tool:
sampling the new data store to obtain a sample file; then converting the sample file to obtain a converted sample file that is familiar to the native scanning tool; then
deploying the native scanning tool upon the converted sample file.

17. The method of claim 16, wherein sampling the new data store to obtain the sample file comprises randomly selecting data elements from the data store.

18. The method of claim 17, wherein the data store is one of a static data store and a data stream.

19. The method of claim 17, wherein converting the sample file to obtain the converted sample file that is familiar to the native scanning tool comprises converting the sample file from an original format to JavaScript Object Notation (JSON).

20. The method of claim 19. wherein the original format is one of a proprietary format and a standard format that remains unfamiliar to the particular native scanning tool.
